(19) United States
(12) Patent Application Publication
(10) Pub. No.: US 2019/0107510 A1
(43) Pub. Date: Apr. 11, 2019

(54) METHOD FOR MONITORING THE FUNCTION OF A SENSOR

(71) Applicant: Endress+Hauser Conducta GmbH+Co. KG, Gerlingen (DE)

(72) Inventor: Tuncay Gülfirat, Esslingen (DE)

(21) Appl. No.: 16/136,725

(22) Filed: Sep. 20, 2018

(30) Foreign Application Priority Data
Oct. 6, 2017 (DE) 10 2017 123 248.6

(51) Int. Cl. G01N 27/416

(52) U.S. Cl. CPC G01N 27/4165; G01N 27/4167

(57) ABSTRACT

The invention relates to a method for monitoring the function of a sensor, comprising: calibrating the sensor, wherein calibration values of at least one of the calibration parameters are determined and stored; repeating the calibration until a trend of the calibration values of the at least one calibration parameter can be determined; determining a trend line from the calibration values of the at least one calibration parameter; and calibrating the sensor, wherein a calibration value estimated on the basis of the trend line is used as a theoretical calibration value of the at least one calibration parameter.

### CROSS-REFERENCE TO RELATED APPLICATION

The present application is related to and claims the priority benefit of German Patent Application No. 10 2017 123 248.6, filed on Oct. 6, 2017, the entire contents of which are incorporated herein by reference.

### TECHNICAL FIELD

The present disclosure relates to a method for monitoring the function of a sensor.

### BACKGROUND

Alone for reasons of process optimization or for monitoring and maintaining limit values, simple operation, safety and reliability are important requirements for measuring points for monitoring processes. Measuring points provide the operator with measured values and information about the current state of the measuring point. In this context, it is, for example, monitored whether limit values are currently exceeded or whether and how sensor-specific parameters, such as the glass impedance of a pH sensor, are maintained. The monitoring relates to current events. A system malfunction or even a system failure generates very high costs compared to the price of the sensor. It is therefore important to address such a malfunction of the measuring point to the greatest extent in advance. The correct and secured measured value is of particular importance in this case.

WO 2004/025223 describes a method for monitoring the function of a sensor in which a prediction of the remaining service life of the sensor up to a required exchange is given on the basis of the development of sensor parameters over time, such as periodically recorded calibration data.

However, irrespectively of the question of the remaining service life, it is necessary to determine the measurement accuracy of the sensor as reliably as possible over the entire service life. In order to achieve this reliability, the operator must nowadays very frequently perform a recalibration/re-adjustment in important processes, even though the sensor system would still work correctly enough. In particular, time, but also material, is thus employed unnecessarily.

### SUMMARY

The object of the present disclosure is therefore to provide a method for monitoring the function of a sensor, and a sensor with an integrated system for function monitoring.

The aim is achieved by the subject matter of the present disclosure. The subject matter of the present disclosure is a method for monitoring the function of a sensor, comprising:

calibrating the sensor, wherein calibration values of at least one of the calibration parameters are determined and stored;

repeating the calibration until a trend of the calibration values of the at least one calibration parameter can be determined;

determining a trend line from the calibration values of the at least one calibration parameter; and

calibrating the sensor, wherein a calibration value estimated on the basis of the trend line is used as a theoretical calibration value of the at least one calibration parameter.

According to an advantageous development, the calibration takes place after a specific time interval. In the time periods between the calibrations, the sensor is operated at its measuring point in a process.

According to an advantageous variant, the at least one calibration parameter is the zero point, the steepness or the isothermal intersection of a calibration function, e.g. a calibration line.

According to an advantageous embodiment, the sensor is adjusted on the basis of a calibration, in particular a calibration based on the trend line of the calibration parameter.

According to an advantageous embodiment, the calibration takes place several times within a specific time interval.

A sensor, in particular for performing the method according to one of the preceding claims, comprising: a primary sensor for detecting a potentiometric measurand, and for outputting a measurand-dependent primary signal, circuit means for processing the primary signal, the circuit means comprising a data memory for calibration values of the at least one calibration parameter; and an evaluation unit for determining a trend line based on the development of the calibration values over time and estimating theoretical calibration values on the basis of the trend line.

### BRIEF DESCRIPTION OF THE DRAWINGS

The present disclosure is explained in more detail based upon the following drawings. These show:

FIG. 1 shows a plot of calibration values of the zero point as a function of the number of calibrations.

### DETAILED DESCRIPTION

Immediately after production, a pH sensor has a calibration line with a zero point at pH 7. That is, at a pH of 7, a voltage of 0 mV is applied at a voltage output of the sensor. The longer the sensor is in operation, the more the zero point of the calibration line shifts. Consequently, the sensor must be calibrated.

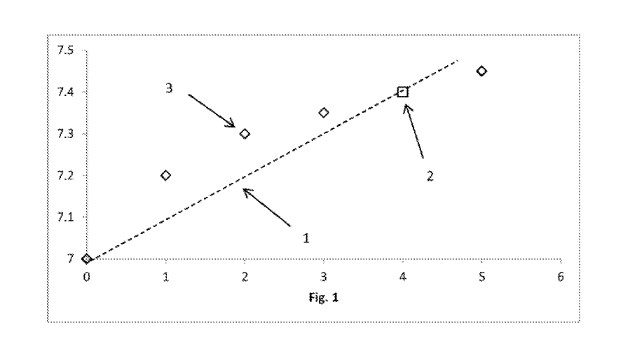

The method for monitoring the function of the sensor comprises the following steps. First, the sensor is manually calibrated a first time after a specific time interval. In the first calibration, various calibration parameters, such as the zero point and slope of the calibration line, are stored. The zero point of the calibration line of the first calibration is at a calibration value 3 of pH 7.2. Then, the sensor is manually calibrated after one and two-time intervals for a second and a third time. In the second and third calibration, a calibration value 3 of pH 7.3 and pH 7.35 are determined. FIG. 1 already shows a trend of the calibration parameter pH after three calibrations. A trend line 1 can be determined on the basis of the trend. The theoretical calibration value 2 for the zero point of the calibration line for the fourth calibration can be estimated on the basis of the trend line 1. A fourth manual calibration of the sensor is superfluous. The sensor is only manually calibrated during the fifth calibration.

The more manually determined calibration values lie along the trend line 1, the stronger is the trend and the more theoretical calibration values can be estimated consecutively. If, for example, the manually determined calibration values of five or six calibrations are close enough to the trend line 1, the seventh and eighth calibration values can theoretically be estimated. This already saves a user two manual calibrations.

What is claimed is:

1. A method for monitoring the function of a sensor, comprising:
calibrating the sensor and determining a calibration value of a calibration parameter;
storing the calibration value;
repeating the calibrating, the determining, and the storing until a trend of the calibration values can be determined;
determining a trend line from the stored calibration values;
estimating a value of the calibration parameter on the basis of the trend line; and
calibrating the sensor using as a theoretical calibration value the estimated value of the calibration parameter.

2. The method according to claim 1, wherein the calibrating occurs after a specific time interval.

3. The method according to claim 1, wherein the calibration parameter is one of: a zero point, a steepness of the calibration function, and an isothermal intersection of a calibration function.

4. The method according to claim 1, further comprising:
adjusting the sensor based on a calibration based on the trend line of the calibration parameter.

5. The method according to claim 1, wherein the calibrating takes place several times within a specific time interval.

6. A sensor, comprising:
a primary sensor embodied to detect a potentiometric measurand and configured to output a measurand-dependent primary signal; and
a circuit configured to process the primary signal, the circuit including a data memory for calibration values, and an evaluation unit configured to determine a trend line based on a development of the calibration values over time and further configured to estimate theoretical calibration values based on the trend line.
